(19) United States
(12) Patent Application Publication
(10) Pub. No.: US 2012/0205922 A1
(43) Pub. Date: Aug. 16, 2012

(54) LOCKING DEVICE OF HINGED DOOR

(76) Inventor: Jin Yong CHOI, Seongnam-si (KR)

(21) Appl. No.: 13/372,148

(22) Filed: Feb. 13, 2012

(30) Foreign Application Priority Data
Feb. 14, 2011 (KR) 10-2011-0012984
Feb. 9, 2012 (KR) 10-2012-0013380

(51) Int. Cl. E05B 65/06; E05C 17/16

(52) U.S. Cl. 292/270

(57) ABSTRACT

Disclosed herein is a locking device of a hinged door. The locking device of the hinged door according to the present invention comprises a trapping part and a fixing part selectively mounted on the hinged door and a door frame and slidly trapped mutually to open the hinged door only at regular intervals. The fixing part comprises a bracket and a clamp rotatably coupled to the bracket. A clamp is partly moved up and down by coupling a trapping means to a keyway connected to a hinge of the bracket. The clamp is supported toward upper parts to maintain a trapping state of the trapping means at the keyway and then limiting a rotation of the clamp. If the trapping means leaves the keyway by a pressure of the hinge of the bracket, the clamp is rotated at the bracket.

### TECHNICAL FIELD

The present invention relates to locking devices of hinged door, and more particularly to a locking device of a hinged door having locking function and trapping-prevention function.

### BACKGROUND ART

Common use for door locks is to keep a person, such as a young child, in a building or room by preventing them from fully opening the door or allowing doors to be opened at regular intervals.

In such the door locks, a hinged door is partly opened until a fixing part is trapped at the end of a rotating bar when the hinged door is opened with the rotation bar trapped at a trapping part for security. In order to wholly open the hinged door, the door is closed to relieve a trapping state of the rotation bar.

At this time, the door locks are adopted in an indoor-open-type as well as an outdoor-open-type locking device of hinged doors.

FIG. 1 shows a conventional locking device 10 mounted on a front door pivoted to the outside. In this locking device 10, a trapping device 11 is fixed at a door frame with bolt combination. A trapping protrusion 12 is formed at one side of the trapping device 11. The trapping protrusion 12 has “C” shape whose left and right are converted.

Also, a fixing device 20 mounted on the hinged door is hinged with the rotation bar 21. The cross-section of the rotation bar 21 is H-shaped. A part of a projection 22 configured with upper and lower parts of the rotation bar 21 is removed to create a rotary motion at a hinge combination part, so that the projection 12 is inserted into the rotation bar 21.

According to the above-mentioned locking device 10, when the hinged door is opened under the condition that the trapping protrusion 12 is inserted into the rotation bar 21, the trapping protrusion 12 is moved at the end of the rotation bar 21, and then trapped at the projection 22. After confirming outsides such as strangers, the hinged door is closed again, and then the insertion of the trapping protrusion 12 is relieved by rotating the rotation bar, thereby opening the hinged door.

Despite the advancements offered by the prior art patents, there is a problem that strangers can move the rotation bar 21 using strings or tilt the rotation bar 21 by pulling the hinged door employing members at opened intervals of the hinged door.

As previously mentioned, the conventional locking devices 10 have been used to confirm strangers when the hinged door is opened but have fatal disadvantage about security.

In addition, when the hinged door is strongly closed, the rotation bar 21 is rotated due to the shock caused by strongly closing the hinged door. At this time, the rotation bar 21 is inserted into the trapping protrusion regardless of the user's intention. As a result, it is very difficult to relieve the locking device when persons are not inside.

Furthermore, a locking state can be relieved by the shock generated when the hinged door is closed under the condition that the rotation bar is positioned at the trapping protrusion.

### DISCLOSURE

### Technical Problem

The present invention has been made in an effort to solve the above problems, and it is an object of the present invention to provide an indoor-open-type locking device of a hinged door capable of performing a locking function for limiting an opening of a hinged door being closed.

It is another object of the present invention is to provide an outdoor-open-type locking device of a hinged door capable of performing a trapping-prevention function for preventing the hinged door from being not to be converted into a locking state regardless of a shock generated when the hinged door is operated.

### Technical Solution

Embodiments of the present invention provide a locking device of a hinged door comprising a trapping part and a fixing part selectively mounted on the hinged door and a door frame and slidly trapped mutually to open a hinged door only at a regular intervals. The fixing part comprises a bracket and a clamp rotatably coupled to the bracket, wherein a clamp is partly moved up and down by coupling a trapping means to a keyway connected to a hinge of the bracket. The clamp is supported toward upper parts to maintain a trapping state of the trapping means at the keyway and then limiting a rotation of the clamp. If the trapping means leaves the keyway by a pressure of the hinge of the bracket, the clamp is rotated at the bracket.

In some embodiments of the present invention, the keyway divides and connects a rotating region and a trapping region, and the trapping means is moved from the trapping region to the rotating region by pushing operation of the clamp to make the clamp to be rotated at the bracket.

In some embodiments of the present invention, a groove is formed at the bracket, and a ball mounted on an elastic element is mounted at the groove to elastically support the clamp.

In some embodiments of the present invention, a trapping groove is formed at an outer peripheral area of a coupling part coupled to the bracket, and the ball is elastically inserted into the trapping groove to limit a rotation angle of the clamp.

In some embodiments of the present invention, the trapping region, rotating region, and trapping means have half-arc shape, and the half-arc shape of the trapping region is formed vertically to make the half-arc shape of the rotating region to be divided into half and connected to a width direction at a center of the trapping region.

In some embodiments of the present invention, the trapping region and trapping means have a quadrangle-shape, and a circular rotation region connected to the trapping region is formed.

In some embodiments of the present invention, the fixing part is mounted onto the door frame, and the trapping part is mounted into the hinged door. If the hinged door is pivoted inside for opening, the clamp connected to the trapping means positioned at the trapping region of the keyway to control an opening of the hinged door. If the clamp is pressured to make the trapping means to be positioned at the rotating region of the keyway, the hinged door is partly or wholly opened.

In some embodiments of the present invention, the clamp connected to the trapping means positioned at the trapping region of the keyway is not rotated freely by mounting the trapping part at the door frame and the fixing part at the hinged door regardless of a shock generated when the hinged door pivoted to the outside is closed.

In some embodiments of the present invention, the clamp has a horseshoe-shape.

### Advantageous Effects

According to an indoor-open-type locking device of a hinged door of the present invention, a fixing part controls an opening of a closed hinged door by limiting a rotation of the fixing part under the condition that the fixing part mounted on a door frame is mutually coupled to a trapping part mounted on the hinged door, thereby improving a stability with respect to a closing of the hinged door.

In an outdoor-open-type locking device of a hinged door, a rotation of the fixing part is limited when the fixing part is mounted on the hinged door, and the trapping part is mounted onto the door frame. As a result, the locking device is not converted into a locking state from a shock generated when the hinged door is closed regardless of a user's intention.

### DESCRIPTION OF DRAWINGS

The foregoing and other objects, features and advantages of the present invention will become more apparent from the following detailed description when take in conjunction with the accompanying drawings in which:

FIG. 1 is a perspective view of a conventional locking device of a hinged door in accordance with the present invention;

FIG. 2 is an exploded perspective view showing a locking device of a hinged door in accordance with a first embodiment of the present invention;

FIGS. 3 to 6 are operation state views illustrating the locking device of the hinged door in accordance with the first embodiment of the present invention;

FIG. 7 is an exploded perspective view showing a locking device of a hinged door in accordance with a second embodiment of the present invention;

FIGS. 8 to 11 are operation state views illustrating the locking device of the hinged door in accordance with the second embodiment of the present invention;

FIG. 12 is a perspective view of a locking device of a hinged door in accordance with a third embodiment of the present invention;

FIG. 13 is an exploded perspective view showing the locking device of the hinged door in accordance with the third embodiment of the present invention; and

FIGS. 14 to 16 are operation state views illustrating the locking device of the hinged door in accordance with the third embodiment of the present invention;

<Brief explanation of essential parts of the drawings>

| | |
|---|---|
| 1: Door Frame, | 2: Hinged door, |
| 100: Locking device, | 110: Trapping part, |
| 111: Latch, | 112: Housing, |
| 120: Fixing part, | 121: Bracket, |
| 121a: Rack, | 121b: Supporter, |
| 121c: Groove, | 122: Clamp, |
| 122a: Coupling part, | 122b: Hanger, |
| 122c: Gap, | 122d: Opening part, |
| 123: Keyway, | 123a: Rotating region, |
| 123b: Trapping region, | 123c: Rotating bush, |
| 123d: Trapping bush, | 124: Trapping means, |
| 125: Ball, | 126: Elastic element, |
| 127: Fixing groove, | 128: Center axis, |
| 129: Trapping groove. | |

### BEST MODE

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the terms “about”, “substantially”, etc. are intended to allow some leeway in mathematical exactness to account for tolerances that are acceptable in the trade and to prevent any unconscientious violator from unduly taking advantage of the disclosure in which exact or absolute numerical values are given so as to help understand the invention.

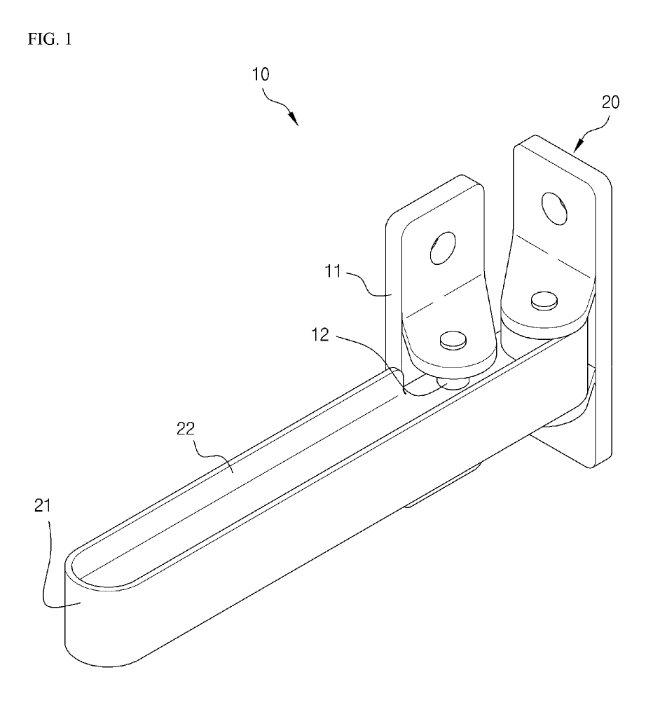

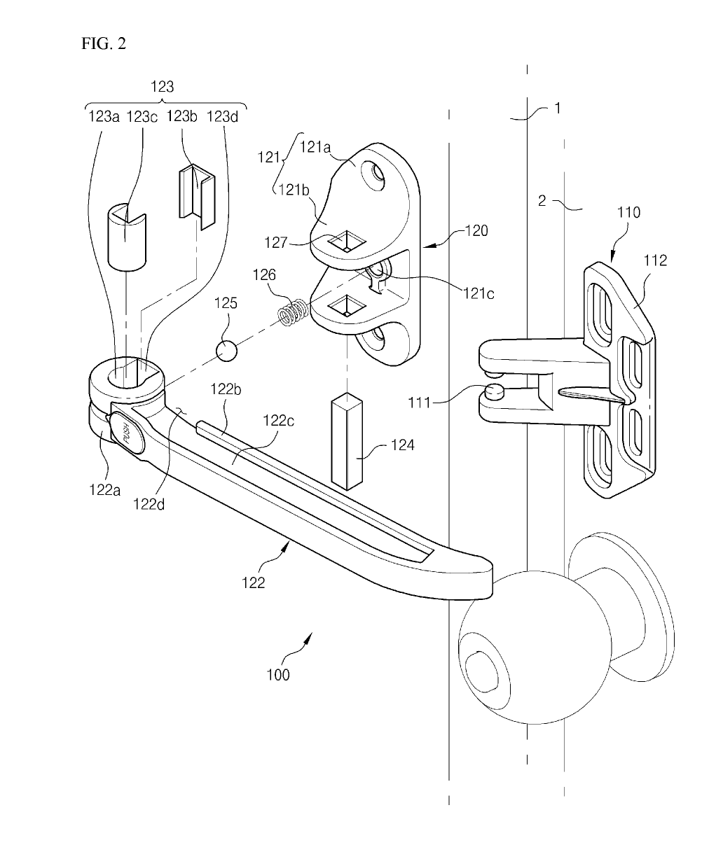

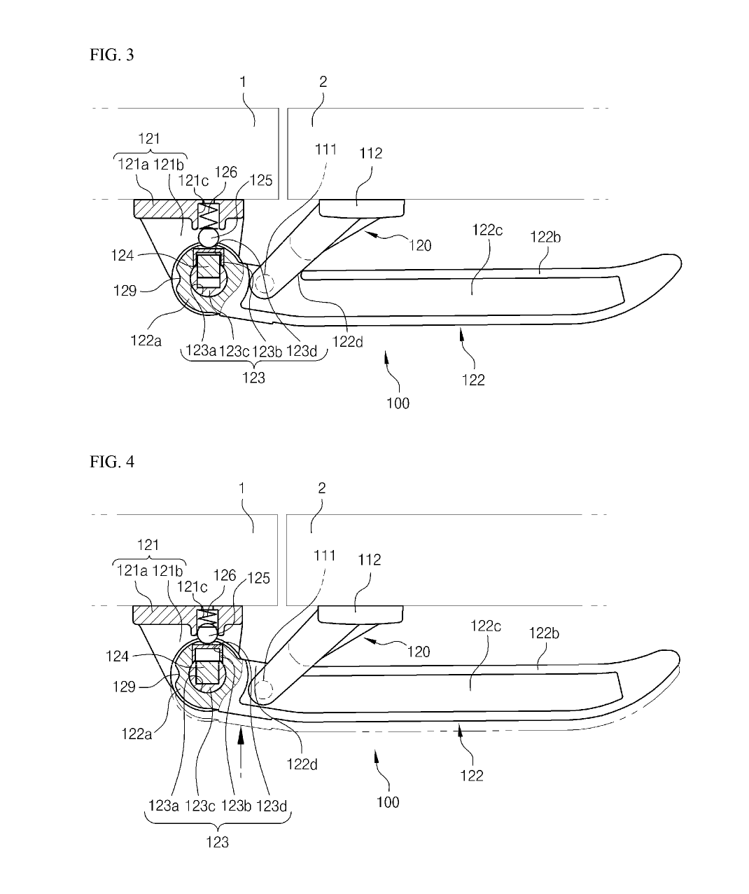

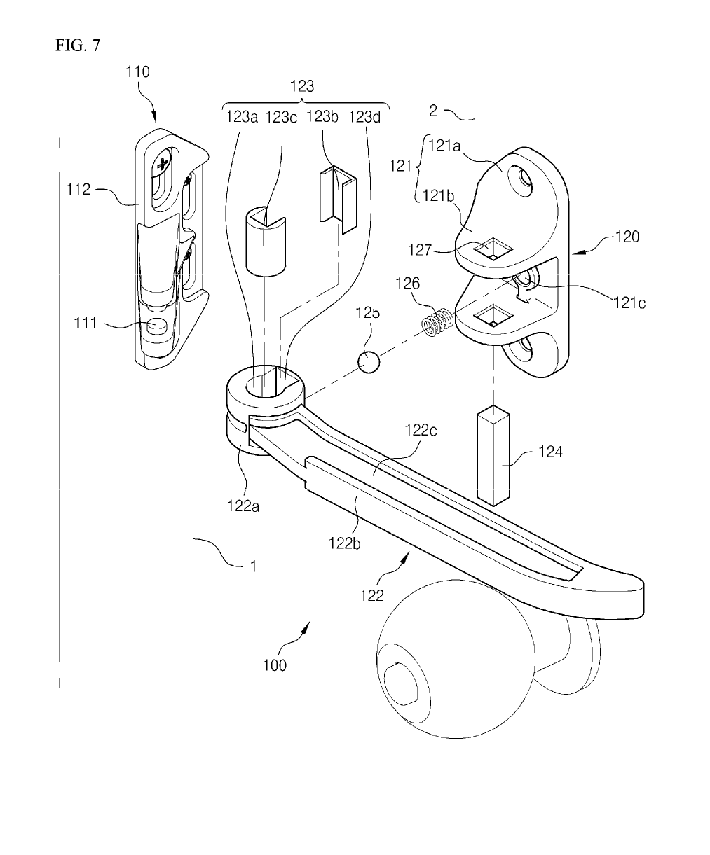

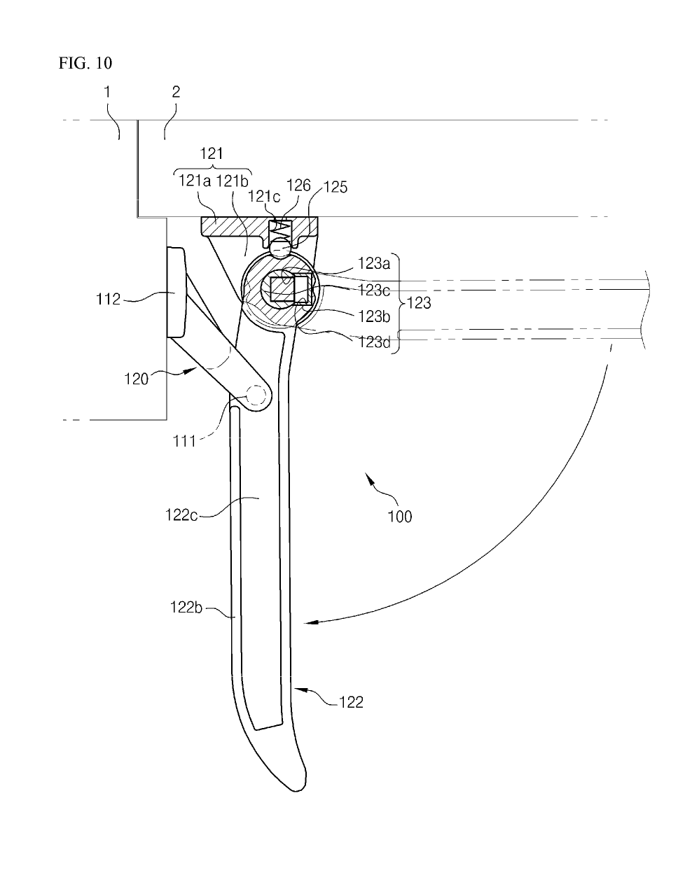

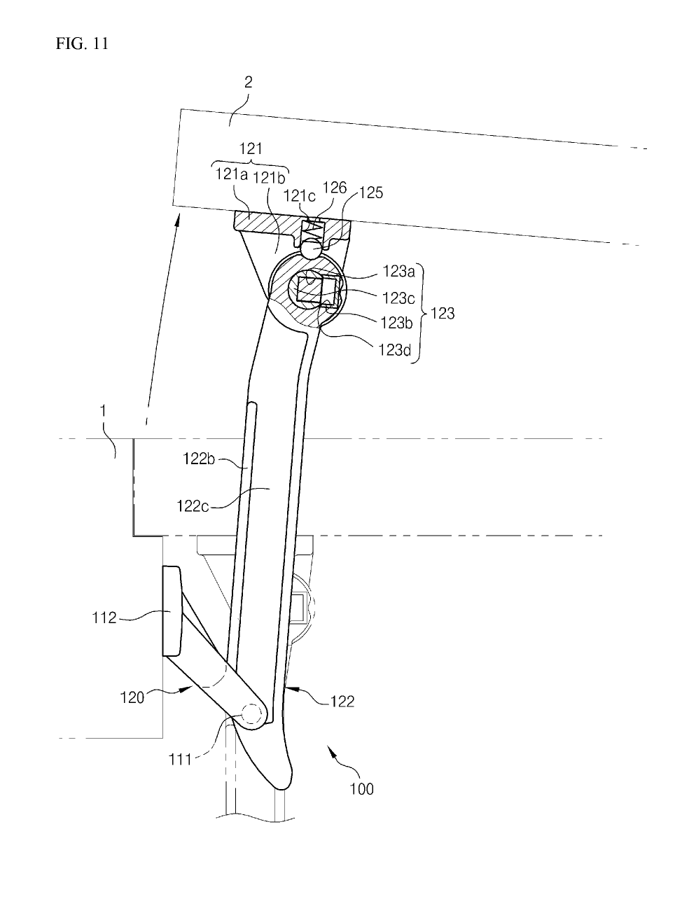

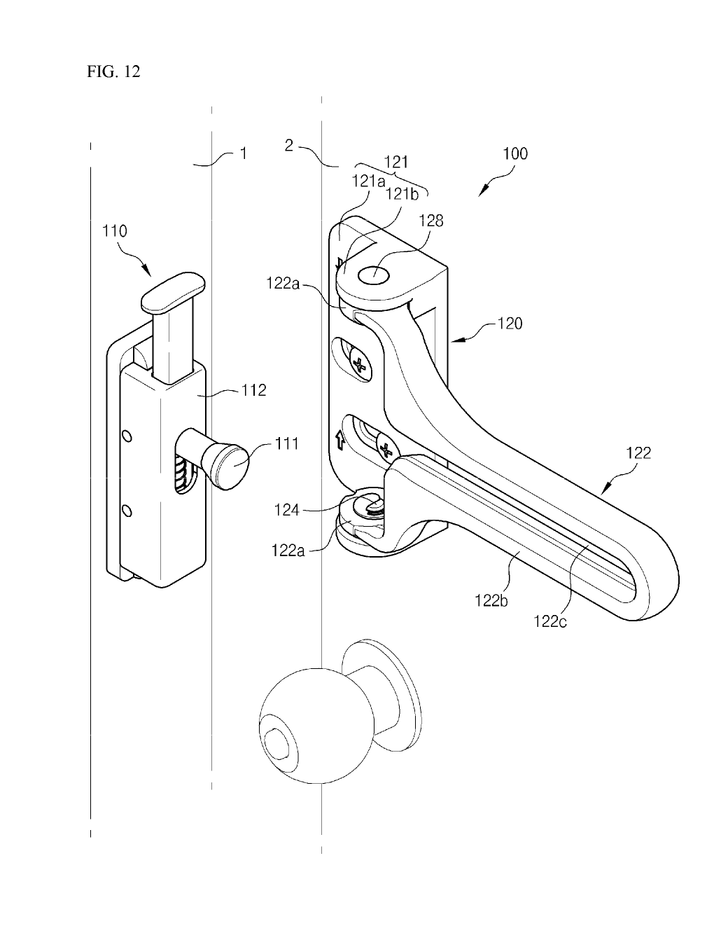

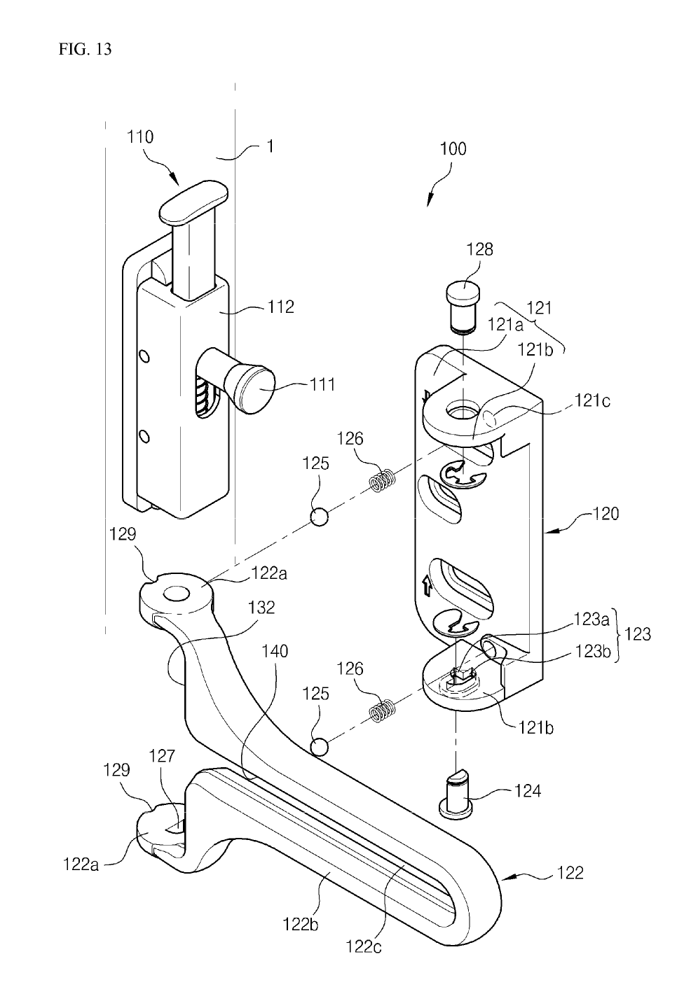

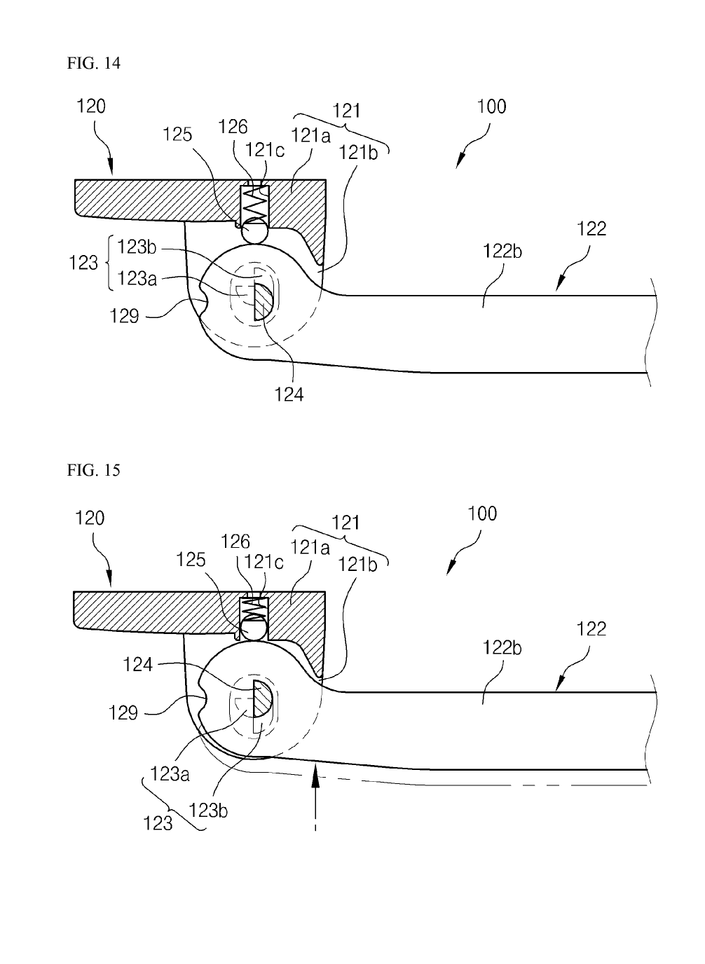

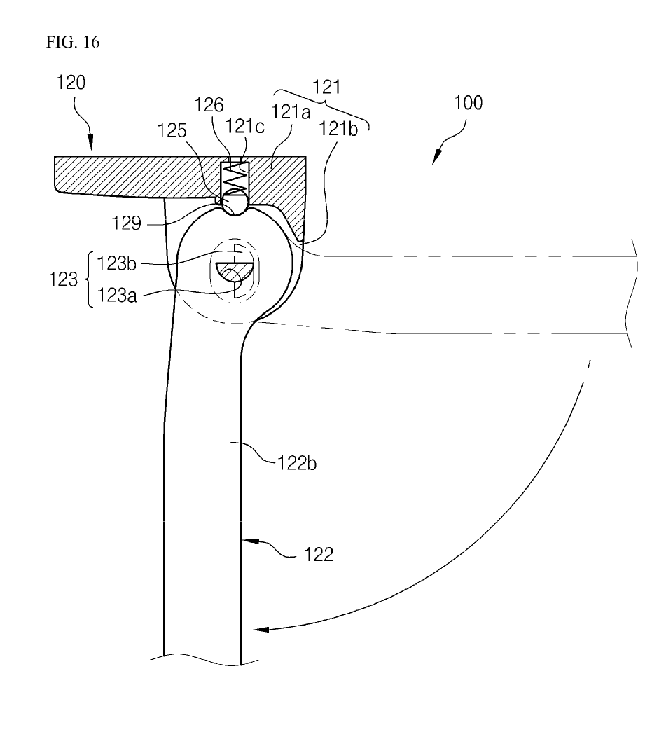

FIG. 1 is a perspective view of a conventional locking device of a hinged door in accordance with the present invention. FIG. 2 is an exploded perspective view showing a locking device of a hinged door in accordance with a first embodiment of the present invention. FIGS. 3 to 6 are operation state views illustrating the locking device of the hinged door in accordance with the first embodiment of the present invention. FIG. 7 is an exploded perspective view showing a locking device of a hinged door in accordance with a second embodiment of the present invention. FIGS. 8 to 11 are operation state views illustrating the locking device of the hinged door in accordance with the second embodiment of the present invention. FIG. 12 is a perspective view of a locking device of a hinged door in accordance with a third embodiment of the present invention. FIG. 13 is an exploded perspective view showing the locking device of the hinged door in accordance with the third embodiment of the present invention. FIGS. 14 to 16 are operation state views illustrating the locking device of the hinged door in accordance with the third embodiment of the present invention;

A locking device of a hinged door 100 according to the present invention comprises a trapping part 110 and a fixing part 120, which are selectively mounted on a hinged door 2 and a door frame 1 and slidly trapped mutually to open the hinged door 2 at regular intervals.

The fixing part 120 comprises a bracket 121 and a clamp 122 rotatably coupled to the bracket 121.

In this case, a trapping means 124 is coupled to a keyway 123 connected to a hinge of the bracket 121, thereby limiting a rotation of the clamp 122 and making the clamp 122 to be rotated by pressing the hinge of the clamp 122

The connection constitution of the clamp 122 and the bracket 121 will be described as followings.

A keyway 123 is formed at a supporter 121b of the bracket 121. A fixing groove 127 is formed at the coupling part 122a of the clamp 122 to be connected to the keyway 12. Then, the trapping means 124 is coupled to the fixing groove 127 by inserting type.

The fixing groove 127 and the trapping means 124 have the same shape and penetrated in one entity to be fixed. The trapping means 124 is coupled to the keyway 123 of the supporter 121b.

At this time, the keyway 123 divides the rotating region 123a and the trapping region 123b and then connected them.

That is, the trapping means 124 is moved from the trapping region 123b to the rotating region 123a by a pushing operation of the clamp 122.

Furthermore, a groove 121c is formed at a rack 121a of the bracket 121. A ball 125 mounted onto an elastic element 126 is mounted at the groove 121c.

The ball 125 mounted on the groove 121c is adhered on lower parts of the coupling part 122a of the clamp 122 to elastically support the clamp 122 toward upper parts.

The reason for this is to maintain the clamp 122 not to be tilted at the bracket 121.

According to a conventional art, if the fixing part 120 mounted on the hinged door 2 strongly closes the hinged door 2, the phenomenon that the clamp 122 is tilted and a gap 122a is trapped with a latch 11 by a shock of the door frame 1 and the hinged door 2 is prevented.

The ball 125 supports the coupling part 122 toward upper parts of the supporter 121b through the elastic element 126, thereby maintaining the trapping means 124 to be positioned at the trapping region 123b of the keyway 123. As a result, the clamp 122 can not be freely rotated at the bracket 121.

In contrast, the coupling part 122a of the clamp 122 is pushed and pressed in order to maintain the fixing part 120 to be fixed with the latch 111 of the trapping part 110.

In case that the clamp 122 is moved toward lower parts by pressure, the trapping means 124 positioned at the trapping region 123b of the keyway 123 is moved to the rotating region 123a, so that a locking state of the bracket 121 and the clamp 122 is relieved.

Subsequently, when the latch 111 of the trapping part 110 is moved to the gap 122c by rotating the clamp 122, a locking state between the trapping part 110 and the fixing part 120 is determined.

In the meanwhile, the shape of the keyway 123 is quadrangle, and the rotating region 123a is connected to the trapping region 123b have a circular shape in the first embodiment.

In order to abrasion of the trapping means 124, a trapping bush 123d and a rotating bush 123c are mounted onto the trapping region 123b and the rotating region 123a, respectively.

For this reason, the clamp 122 is continuously received a force created by the ball's 125 upward pulling capacity through the elastic element 126. As a result, the clamp 122 can not be freely rotated by maintaining the trapping means 124 to be inserted into the trapping region 123b or the trapping bush 123d mounted in the trapping region 123b.

When the fixing part 120 is converted into a trapping state of the trapping part 110, the trapping means 124 is relieved from the trapping region 123b by pressing and pushing the coupling part 122a of the clamp 122. Then, the trapping means 124 is inserted into the rotating region 123a or the rotating bush 123c to relieve a mutual locking state between the bracket 121 and the clamp 122, thereby making the clamp 122 to be rotated.

The trapping groove 129 is formed at an outer peripheral area of the coupling part 122a of the clamp 122 connected to the bracket 121. When the clamp 122 is vertically rotated, the ball 125 is elastically inserted into the trapping groove 129 to limit a rotation angle of the clamp 122.

In the above-mentioned locking device of the hinged door 100, the trapping means 122a may be installed in a pair of the coupling parts 122a formed at the clamp 122, respectively.

Also, the trapping means 124 is mounted in any one of the coupling part 122a, and the other of the coupling part 122a is hinged with a center axis 128.

As shown in FIGS. 14 to 16, the trapping region 123b, the rotating region 123a, and the trapping means 124 have a half-arc shape in the second embodiment of the keyway 123.

In particularly, the half-arc shape of the trapping region 123b is formed vertically to make the half-arc shape of the rotating region 123a to be divided into half and connected to a width direction at a center of the trapping region 123b.

In advance, as shown in FIG. 2, the locking device of the hinged door 100 according to the present invention will be described in more detail.

In the locking device of the hinged door 100 mounted on the hinged door 2, which is pivoted inside and opened, the fixing part 120 is mounted on the door frame 1, and the trapping part 110 is mounted on the hinged door 2.

In this case, an opening part 122d is formed inside the clamp 122. The opening part 122d introduces the latch 111 of the trapping part 110 to be inserted to the gap 122c of the clamp 122.

Like this, under the condition that the latch 111 is inserted into the gap 122c of the clamp 122, if the hinged door 2 is pivoted inside for opening, the clamp 122 connected to the trapping means 124 positioned at the trapping region 123b of the keyway 123 to control an opening of the hinged door 2.

As shown in FIGS. 3 and 4, if the hinge of the clamp 122 is pressured to make the trapping means 124 to be positioned at the rotating region 123a of the keyway 123, the clamp 122 is freely rotated.

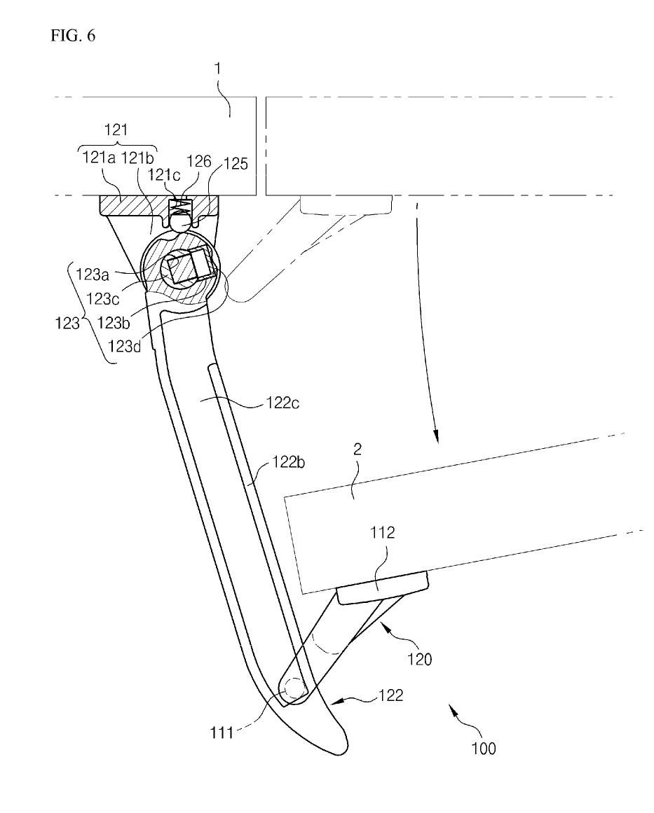

In other words, as shown in FIG. 6, if the hinged door 2 is opened under the condition that the latch 11 is installed on the gap 122c, the latch 111 and clamp 122 is slidly trapped mutually to open the hinged door 2 at regular intervals as much as the length of the clamp 122.

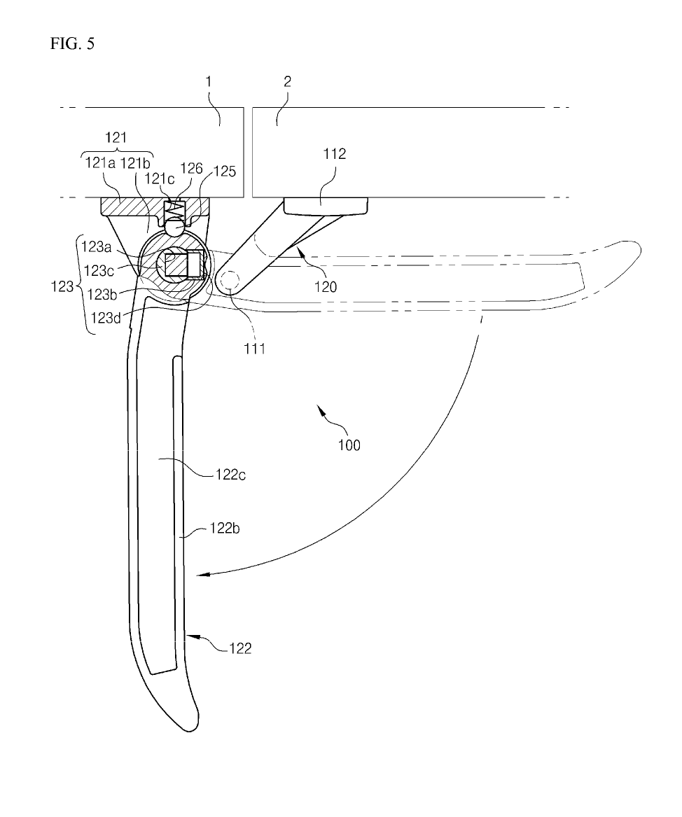

As shown in FIG. 5, if the clamp 122 is rotated with the latch 111 being not trapped under the condition that the clamp 122 is pressured to make the trapping means 124 to be positioned at the rotating region 123a of the keyway 123, the hinged door 2 can be opened wholly.

As shown in FIGS. 7 to 11, the locking device of the hinged door 100 according to the second embodiment of the present invention will be described hereinafter.

In the locking device of the hinged door 100 mounted on the hinged door 2, which is pivoted outside and opened, the fixing part 120 is mounted on the hinged door 2, and the trapping part 110 is mounted on the door frame 1.

In this case, the clamp 122 connected to the trapping means 124 positioned at the trapping region 123b of the keyway 123 is not freely rotated regardless of strong shock generated when the hinged door 2 pivoted to the outside is closed.

And, the opening part 122d for introducing the latch 11 of the trapping part 110 to be inserted into the gap 122c of the clamp 122 is formed on the exterior of the clamp 122.

The clamp 122 is partly moved up and down by coupling the trapping means 124 to the keyway 123 connected to the hinge of the bracket 121. For this reason, the clamp 122 is elastically supported toward upper parts.

Resultantly, the trapping means 124 is maintained in a trapping state at the keyway 123 to limit a rotation of the clamp 122.

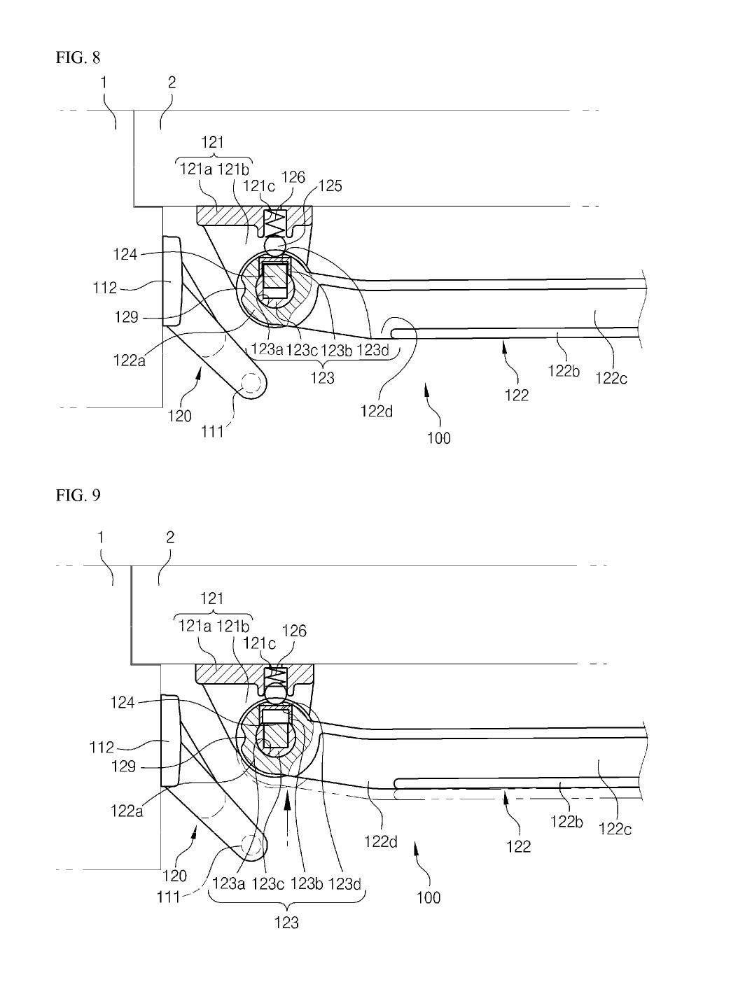

As shown in FIGS. 8 and 9, if the clamp 122 is pressed to make the trapping means 124 to be positioned at the rotating region 123a of the keyway 123, the clamp 122 can be rotated at the bracket 121.

More concretely, the fixing groove 127 having a square shape is formed on the supporter 121b of the bracket 121. The keyway 123 is formed at the coupling part 122a of the clamp 122.

The trapping means 124 is moved from the trapping region 123b to the rotating region 123a by pushing operation of the clamp 122 to make the clamp 122 to be rotated at the bracket 121.

As shown in FIG. 11, if the hinged door 2 is pivoted to the outside for opening under the condition that the latch 111 is inserted to the gap 122c formed at the clamp 122 being freely rotated, the latch 111 and clamp 122 is slidly trapped mutually to open the hinged door 2 at regular intervals as much as the length of the clamp 122.

The opening part 122d is formed inside/outside the clamp 122 to be used irrespective of opened direction of the hinged door 2, thereby improving compatibility.

As shown in FIGS. 12 and 13, the locking device of the hinged door 100 according to the third embodiment of the present invention will be described hereinafter.

The fixing part 120 comprises the bracket 121 fixed at the hinged door 2 and the clamp 122 rotatably connected to the bracket 121.

The bracket 121 comprises the rack 121a and the supporter 121b vertically formed at both upper sides of the rack 121a. A hole is formed at the rack 121a, and the rack 121a is fixed through screws at edge boundary of the hinged door 2. The supporter 121b is vertically mounted at both sides of the rack 121a.

The clamp 122 includes a pair of the coupling parts 122a, which are corresponded mutually and a hanger connected to a hinge.

In this case, the hanger 122b is bended in a horseshoe shape to form the gap 122c. The trapping part 110 is selectively trapped to the gap 122c, so that the hinged door 2 is opened only at regular intervals.

In this case, the trapping part 110 exposes the latch 111 to a front area. The latch 111 is vertically movable in a housing 112. This latch 111 is trapped at the gap 122c of the clamp 122 to determine an opening degree of the hinged door 2.

Although the present invention has been described herein with reference to the foregoing embodiments and the accompanying drawings, the scope of the present invention is defined by the claims that follow. Accordingly, those skilled in the art will appreciate that various substitutions, modifications and changes are possible, without departing from the spirit of the present invention as disclosed in the accompanying claims. It is to be understood that such substitutions, modifications and changes are within the scope of the present invention.

1. A locking device of a hinged door comprising:
a trapping part and a fixing part selectively mounted on a hinged door and a door frame and slidly trapped mutually to open the hinged door only at a regular intervals, wherein the fixing part comprises:
a bracket; and
a clamp rotatably coupled to the bracket, wherein a clamp is partly moved up and down by coupling a trapping means to a keyway connected to a hinge of the bracket, and
wherein the clamp is supported toward upper parts to maintain a trapping state of the trapping means at the keyway and then limiting a rotation of the clamp, and
wherein if the trapping means leaves the keyway by a pressure of the hinge of the bracket, the clamp is rotated at the bracket.

2. The locking device of claim 1, wherein the keyway divides and connects a rotating region and a trapping region, and
wherein the trapping means is moved from the trapping region to the rotating region by pushing operation of the clamp to make the clamp to be rotated at the bracket.

3. The locking device of claim 1, wherein a groove is formed at the bracket, and a ball mounted on an elastic element is mounted at the groove to elastically support the clamp.

4. The locking device of claim 3, wherein a trapping groove is formed at an outer peripheral area of a coupling part coupled to the bracket, and
wherein the ball is elastically inserted into the trapping groove to limit a rotation angle of the clamp.

5. The locking device of claim 2, wherein the trapping region, rotating region, and trapping means have half-arc shape, and
wherein the half-arc shape of the trapping region is formed vertically to make the half-arc shape of the rotating region to be divided into half and connected to a width direction at a center of the trapping region.

6. The locking device of claim 2, wherein the trapping region and trapping means have a quadrangle-shape, and a circular rotation region connected to the trapping region is formed.

7. The locking device of claim 1, wherein the fixing part is mounted onto the door frame, and the trapping part is mounted into the hinged door, and
wherein if the hinged door is pivoted inside for opening, the clamp connected to the trapping means positioned at the trapping region of the keyway to control an opening of the hinged door, and
wherein if the clamp is pressured to make the trapping means to be positioned at the rotating region of the keyway, the hinged door is partly or wholly opened.

8. The locking device of claim 1, wherein the clamp connected to the trapping means positioned at the trapping region of the keyway is not rotated freely by mounting the trapping part at the door frame and the fixing part at the hinged door regardless of shock generated when the hinged door pivoted to the outside is closed.

9. The locking device of claim 1, wherein the clamp has a horseshoe-shape.

10. The locking device of claim 2, wherein the fixing part is mounted onto the door frame, and the trapping part is mounted into the hinged door, and
wherein if the hinged door is pivoted inside for opening, the clamp connected to the trapping means positioned at the trapping region of the keyway to control an opening of the hinged door, and
wherein if the clamp is pressured to make the trapping means to be positioned at the rotating region of the keyway, the hinged door is partly or wholly opened.

11. The locking device of claim 2, wherein the clamp connected to the trapping means positioned at the trapping region of the keyway is not rotated freely by mounting the trapping part at the door frame and the fixing part at the hinged door regardless of shock generated when the hinged door pivoted to the outside is closed.
